(19) United States
(12) Patent Application Publication
(10) Pub. No.: US 2021/0166185 A1
(43) Pub. Date: Jun. 3, 2021

(54) Motivational System

(71) Applicant: Veralany Pty Ltd., Briar Hill (AU)

(72) Inventor: Luke David Canham, Briar Hill (AU)

(21) Appl. No.: 16/699,403

(22) Filed: Nov. 29, 2019

(51) Int. Cl. G06Q 10/08; G06Q 30/06; G06Q 30/02

(52) U.S. Cl. CPC G06Q 10/08; G06Q 30/02; G06Q 30/0601

(57) ABSTRACT

A motivational system is adapted for determining a user's personal purpose, and for using that personal purpose to continuously motivate the user to achieve his or her purpose. The system transmits, via a central computer, a sign up form that includes a field for receiving a shipping address of the user. Once this has been received, a plurality of questions about reasons that motivate a user are transmitted, and a plurality of answers to the questions are received, and most pertinent reasons that motivate the user are determined. The most pertinent reasons are transmitted to a manufacturer computer so that a physical anchor that is adapted to be worn by the user may be manufactured, which has been imprinted with the most pertinent reasons. The physical anchor is then shipped to the shipping address of the user.

### BACKGROUND OF THE INVENTION

### Field of the Invention

This invention relates generally to motivational systems, and more particularly to a motivational system that develops a physical anchor to reinforce the reasons a user has for maintaining motivation.

### Description of Related Art

The prior art teaches a wide range of motivational systems for helping people improve themselves. Some are implemented in educational courses or group events designed to inspire and motivate participants after completion.

Other prior art motivational systems may be in the form of jewelry, notebooks, clothing, etc., often printed with inspirational quotes or meaningful phrases decided by a manufacturer.

The prior art teaches motivational systems such as described herein. However, the prior art does not teach a motivational system which includes a computer implemented method for determining a reason to maintain motivation that is unique to the user, and also a computer implemented method of producing and delivering to the user a physical item (“anchor”) that includes reasons imprinted thereupon to maintain the user's motivation by constant physical reminder. The present invention fulfills these needs and provides further advantages as described in the following summary.

### SUMMARY OF THE INVENTION

The present invention teaches certain benefits in construction and use which give rise to the objectives described below.

The present invention provides a motivational system that is adapted for determining a user's personal purpose, and for using that personal purpose to continuously motivate the user to achieve his or her purpose. The system transmits, via a central computer, a sign up form that includes a field for receiving a shipping address of the user. Once this has been received, a plurality of questions about reasons that motivate a user are transmitted, and a plurality of answers to the questions are received, and most pertinent reasons that motivate the user are determined. The most pertinent reasons are transmitted to a manufacturer computer so that a physical anchor that is adapted to be worn by the user may be manufactured, which has been imprinted with the most pertinent reasons. The physical anchor is then shipped to the shipping address of the user.

A primary objective of the present invention is to provide a motivational system having advantages not taught by the prior art.

Another objective is to provide a motivational system that includes a computer implemented method for determining a reason to maintain motivation that is unique to the user, and also a computer implemented method of producing and delivering to the user a physical item (“anchor”) that includes reasons imprinted thereupon to maintain the user's motivation by constant physical reminder.

A further objective is to provide a motivational system which results in a physical product that is customized to remind the user of what motivates him or her according to the determinations made by the computer implemented system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of a motivational system according to one embodiment of the present invention;

FIG. 2 is a flow diagram of the operation of the motivational system;

FIG. 3 is a diagram of a journey of a user that is at the core of the motivational system;

FIG. 4 is a diagram of the operation of a web site that facilitates the journey illustrated in FIG. 3;

FIG. 5 is a diagram of the motivational system illustrating the integration of the journey of FIG. 3 and the web site functionality of FIG. 4;

FIG. 6 is an illustration of a web page that provides a sign up form that includes a field for receiving a shipping address of the user; and

FIG. 7 is a perspective view of one embodiment of a physical anchor that is produced via the motivational system of FIG. 1.

### DETAILED DESCRIPTION OF THE INVENTION

The above-described drawing figures illustrate the invention, a motivational system 10 for determining a user's personal purpose, and for using that personal purpose to continuously motivate the user to achieve his or her purpose.

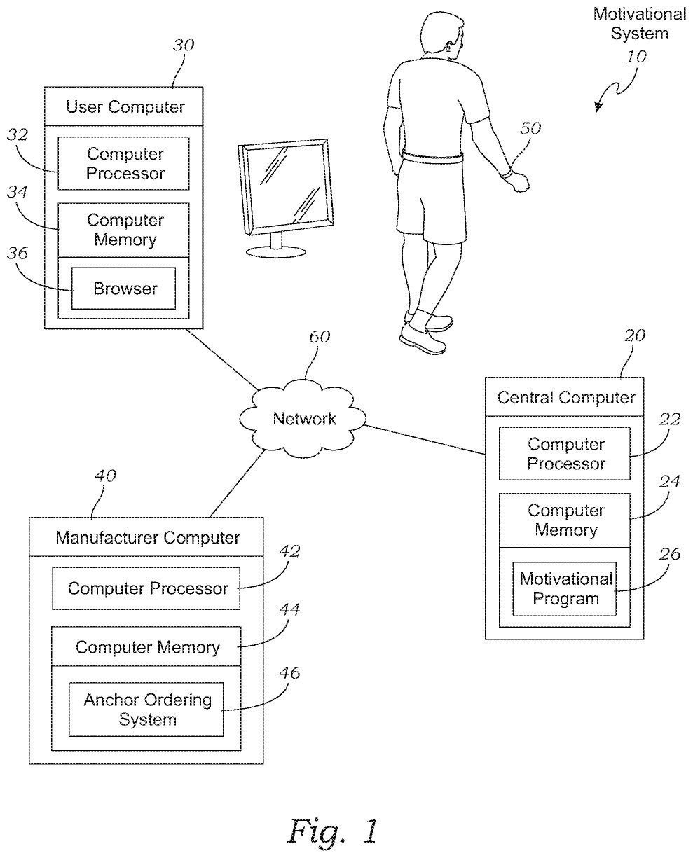

FIG. 1 is a block diagram of the motivational system 10 according to one embodiment of the present invention. As shown in FIG. 1, the motivational system 10 includes a central computer 20 that interacts with a user computer 30 to perform the functions of the motivational system 10. The central computer 20 also interacts with a manufacturer computer 40 to place orders for physical anchor products 50 which have been customized, as described below, to implement the motivational system 10.

For purposes of this application, the term “computer” (or any other similar term, such as “server,” “computer device,” “electronic device,” “user device,” etc.), refers to any form of electronic device or plurality of devices having at least one computer processor, e.g., a central processing unit (CPU), and some form of computer memory having the capability to store data. The server may comprise hardware, software, and firmware for receiving, storing, and/or processing data as described below. The hardware may be in a single unit, or operably connected via a network. For example, a computer or server may comprise any of a wide range of digital electronic devices, including, but not limited to, a server, a desktop computer, a laptop, a smart phone, a tablet, or any form of electronic device capable of functioning as described herein.

As shown in FIG. 1, the central computer 20 includes a computer processor 22 and a computer memory 24, and the computer memory 24 has operably installed thereupon a motivational program 26 that provides the functionality described in greater detail below. The central computer 20, the user computer 30, and the manufacturer computer 40 each have the capability to access a network, and are operably connected thereby. The user computer 30 has a computer processor 32 and a computer memory 34, and may include an application 36 (e.g., a web browser, media player, etc.) capable of running the motivational program 26. The manufacturer computer 40 has a computer processor 42 and a computer memory 44, wherein the user may use the motivational program 26 to order an anchor 50 using an anchor ordering system 46 of the manufacturer computer 40, whose function is described below.

While a certain arrangement of computers is shown in FIG. 1, this does not require any particular arrangement of physical computer components, and one single conceptual configuration is illustrated but should not limit actual implementations. For example, a single computer could theoretically perform all of the described functions, or each function could be performed by multiple separate computer devices, as is known in the art. For example, the central computer 20 and the manufacturer computer 40 could both be performed on a single physical computer, or each function could be distributed over a series of computers. For example, multiple anchor products (described below) could be manufactured at different locations each with a different manufacturer computer 40. Any configuration known in the art should be considered within the scope of the present invention.

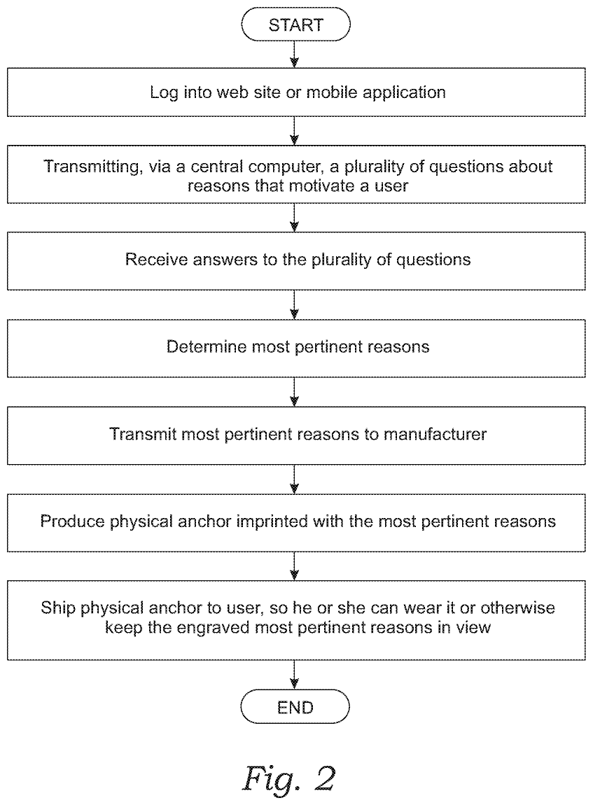

FIG. 2 is a flow diagram of the operation of the motivational system 10. As shown in FIG. 2, the motivational system 10 may be executed by the motivational program 26 illustrated in FIG. 1. As shown in FIG. 2, in this embodiment the system 10 starts when the user logs into a website or mobile application 36 via the user computer 30 to access the program 26, using methods well known in the art.

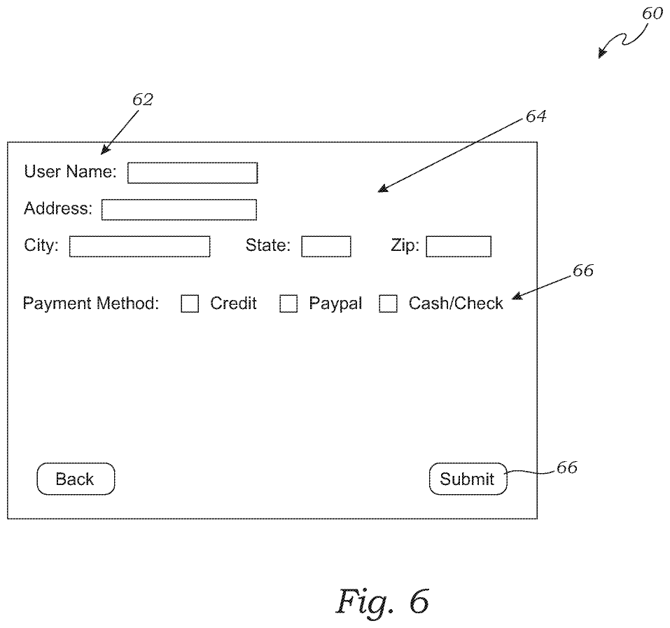

As shown in FIG. 2, the central computer 20 generates and transmits forms which enable the user to provide account information in form fields, including at least a shipping address (shown in FIG. 6), but also typically including name, email address, phone number(s), and other user information typically gathered by those skilled in the art. This is submitted to the central computer 20 by the user, and an account may be formed, payment received, etc.

Once an account is formed (or the user has logged in), the program 26 transmits, via the central computer 20, a plurality of questions about reasons that motivate a user, wherein the user provides answers to the questions. The questions are designed to encourage a user to reflect on his or her past, such as significant people in the user's life, or times when he or she felt most excited or inspired. One example of such a question follows: “Recall an experience that was challenging but also rewarding. Although difficult, it was worthwhile, and you would do it again. What is it?” Another question might be, “Is there one thing you would like to tell yourself as a reminder every day? It could be a reminder or something you would like to tell your younger self.” Other questions might focus on the user's most deeply felt convictions or sympathies, to investigate the most important values defined by the user. While examples of possible questions are disclosed herein, it should be understood that one skilled in the art may device many similar questions and other forms of inquiry, and any particular structure of inquiry may be utilized within the scope of the present invention, so long as the user is assisted in the introspection process.

The program 26 then transmits the user's answers to the central computer 20, where they undergo a review process. The program 26 then helps the user to determine the most pertinent reasons that motivate the user. Afterward, areas which show “themes” in your reasons will be highlighted so you may evaluate and develop them further. In one embodiment, the program 26 provides suggestions based on the answers. Suggestions should be in line with described passions, purpose, etc.

One specific example of a suggestion process is where an actual person reviews the answers transmitted by the user and extracts key words/phrases and repeated sentiments from the answers. Sometimes phrases may be “translated” to key words which are candidates for reasons. For example, if a user expresses worry about those in need, the reviewer may write “compassion,” “empathy,” or similar. Other times, the answer is already in condition for being a pertinent reason, such as when the user directly states family names, objects, etc. that mean the most to him or her. Words selected by the reviewer are shared with the user, wherein the user may tailor the words further. For example, “travel” may become “wanderlust,” or several words can become a theme such as “family.” Other typical most pertinent reasons include friends, ocean, exercise, adventure, etc. Anything which may remind the user what motivates him or her may be included in the final reasons.

Once the user has agreed on which reasons are the most pertinent, the motivational program 26 then transmits the most pertinent reasons to the manufacturer computer 40, wherein the manufacturer computer 40 notifies a manufacturer to produce the physical anchor 50 imprinted with the reasons. For the purposes of this application, “imprinted” is hereby defined to include any form of printing, engraving, etching, molding, embossing, etc., as long as the anchor 50 is displaying the reasons to the user. The physical anchor 50 is adapted to be worn by the user and is shipped to the shipping address of the user so that he or she may wear it, as on the bracelet in FIG. 1 and discussed in greater detail below. For the purposes of this application, “wear/worn” is hereby defined to include any method of wearing, affixing, carrying, holding, etc. an object, so long as the anchor 50 and therefore the imprinted reasons are kept in view of the user.

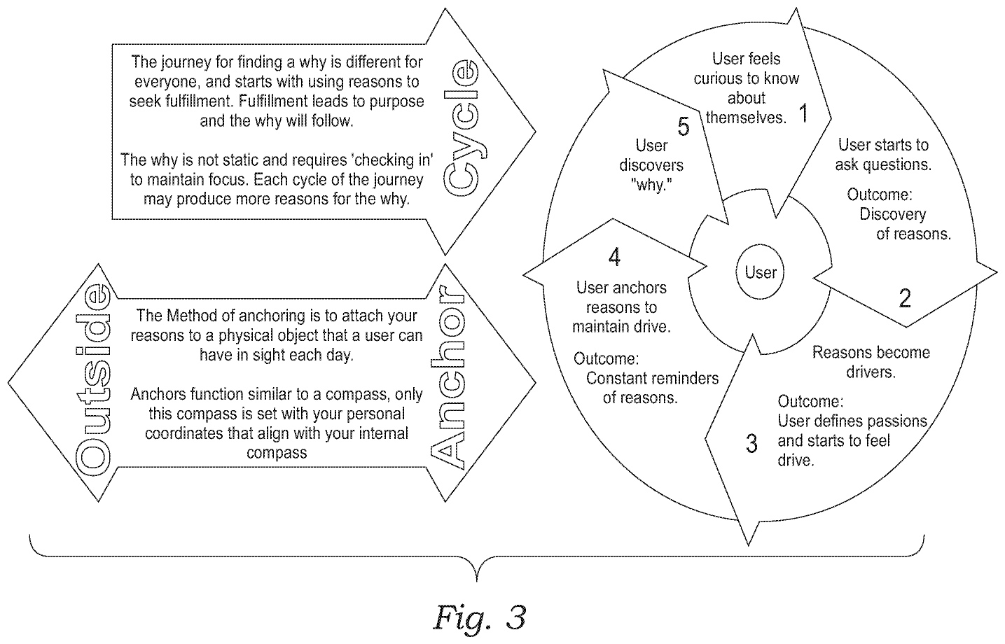

FIG. 3 is a diagram of a journey of a user that is at the core of the motivational system 10. The journey may by cyclical and results in the anchor 50 that the user interacts with in daily life. The journey is the internal component of the motivational program 26 and varies for each user; it is intended to assist in finding reasons for what motivates the user to achieve their purpose, or “why.” As shown in FIG. 3, the user first feels a desire to introspect and discover a purpose. As described above, the user is then asked the questions which result in reasons for what motivates him or her. The reasons become “drivers” and help the user to define his or her passions. Next, the reasons are physically anchored so that the user is constantly reminded of them and drive is maintained. This method of anchoring is to keep the anchor 50 in sight each day, so that it may act as a metaphorical compass for staying motivated. Now that drive and inspiration are present, the why becomes clear in the final step of the journey. The why is the innermost component of the motivational system 10, being the user's personal sense of purpose and motivation in life.

The why is not static and requires “checking in” on the most pertinent reasons to maintain focus and purpose. The user may go through many cycles of the journey, and each cycle may produce more reasons for the why.

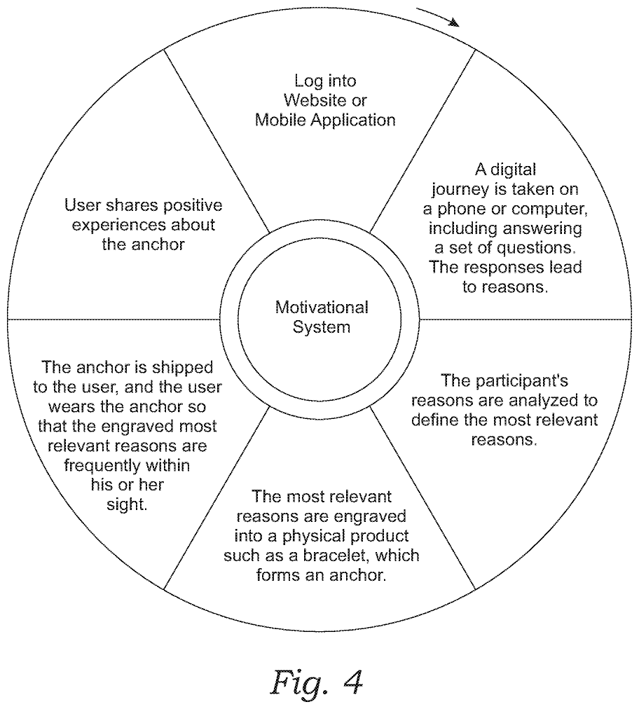

FIG. 4 is a diagram of the operation of the web site 36 which is the intermediate component of the motivational system 10 and facilitates the journey illustrated in FIG. 3. The web site 36 is the “how” of the motivational program 26, being the method of implementing the idea (“why”) and the physical actions and tools which do so (“what”). As shown in FIG. 4, the user first logs in to the website or mobile application 36 to access the motivational program 26, then undertakes the journey described in FIG. 3. Once the user receives the physical anchor 50, positive experiences may be shared with others so that the motivational system 10 can take more users through the cycle.

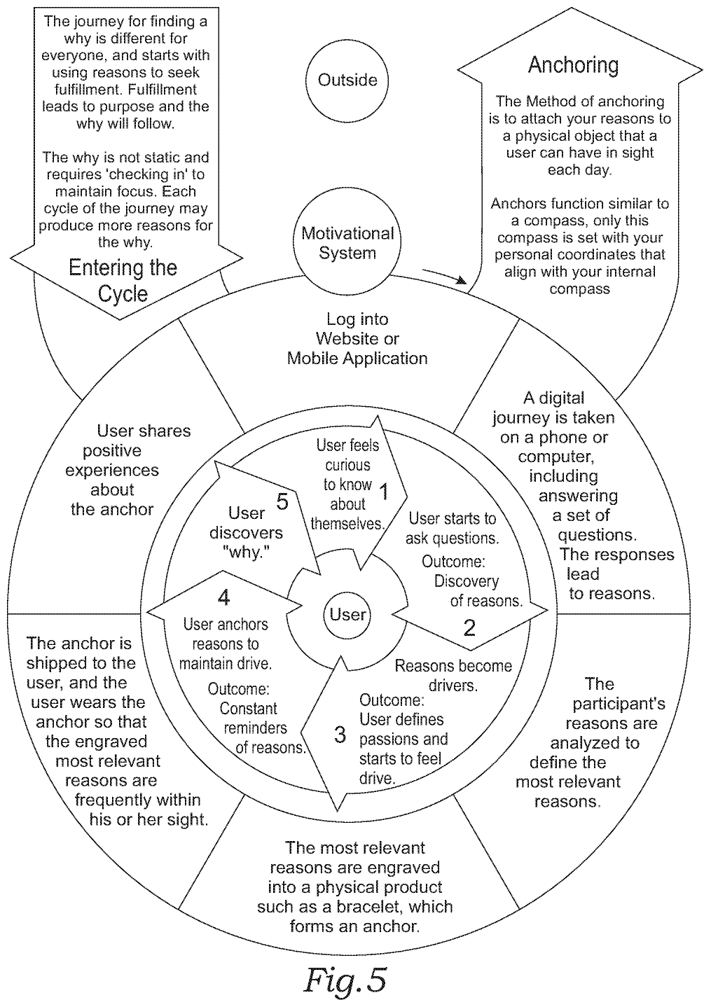

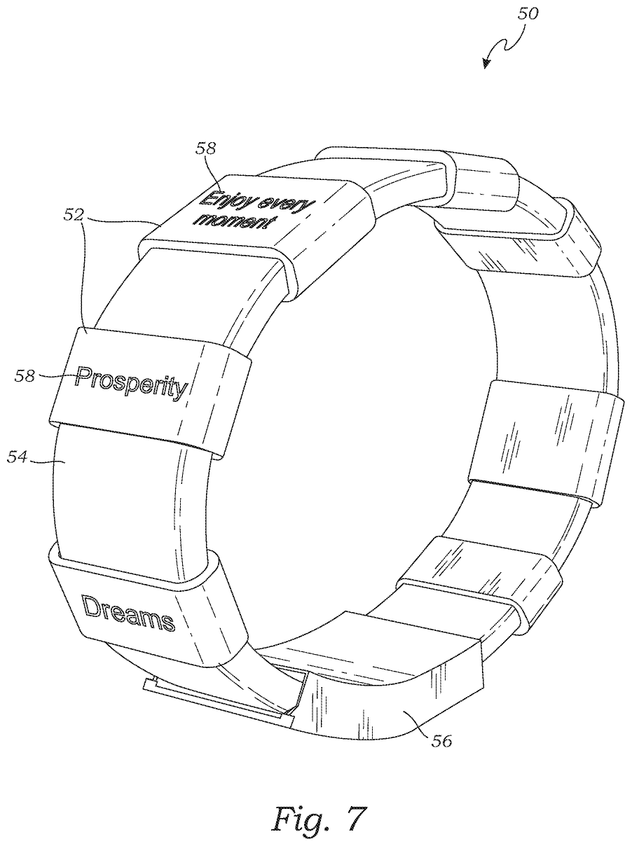

FIG. 5 is a diagram of the motivational system 10 illustrating the integration of the journey of FIG. 3 and the web site method of FIG. 4. As shown in FIGS. 3-5, the motivational system 10 functions similar to some “circular” value models typically applied to business operations, i.e., a layered circle having an innermost circle representing “why” (purpose/mission), an intermediate circle representing “how” (what methods make the program effective), and an outermost circle representing “what” (tools/actions used to achieve a desired outcome). In this model, the “why” is in the journey of FIG. 3, the “how” is in the website operation of FIG. 4, and the “what” is the physical anchor 50 which connects the program to the outside world. The physical anchor 50 is shown in FIG. 7 and discussed in greater detail below.

FIG. 6 is an illustration of one embodiment of a sign up form 60 that is transmitted from the central computer 20 and displayed via the browser 36. The sign up form 60 has a user name field 62, address fields 64, and payment information fields 66 for receiving payment. The shipping address may be used to send the physical anchor 50 to the user, as discussed above. Fields may also collect other data to create a more personalized account. The sign up form should gather at least enough information to ship the anchor 50 to the user, once the user has decided on the most pertinent reasons to be imprinted on the anchor 50.

FIG. 7 is a perspective view of one embodiment of the physical anchor 50 that is produced via the motivational system 10 of FIGS. 1-6. In this embodiment, the physical anchor 50 includes charms 52 which may each include an imprinted reason 58 determined by the motivational program 26. The charms 52 may be in the form of links, buttons, or any other object capable of receiving the imprinted reasons 58. The charms 52 may be attached to a base item 54 which the user can keep in sight on a daily basis.

In this embodiment, the charms 52 are in the form of plates that are mounted around the base item 54, in this case a bracelet adapted to be worn around the wrist of the user, as shown in FIG. 1. The charms 52 may be constructed of metal, plastic, or any other materials which may be affixed to the base item 54. In an alternative embodiment, the base item 54 may be in the form of a necklace, or any other item worn by the user, or otherwise kept on the person of the user so that the reasons are within his or her view frequently during the day. In an alternative embodiment, the user may choose not to affix the charms 52 to any base item, and instead view the charms 52 via another method (e.g., carried in a pouch, placed on a mantle, etc.).

In this embodiment, the base item 54 is in the form of a bracelet/wristband having the charms 52 spaced a distance apart along the length of the bracelet 54. The bracelet 54 may be constructed of leather, fabric, or any other material commonly used in the art. The bracelet 54 may also include a fastener 56 so that it may be easily taken on and off of the user's wrist.

The fastener 56 may be any type of standard fastener, e.g., a buckle, a latch mechanism, a hook and loop fastener, or any other typical fastener known in the art. In this embodiment, the base item 54 is in the form of a bracelet, but it may also be other types of wearable accessories (e.g., a necklace, pin, printed shirt, etc.), or any other item to which the charm 52 may be affixed (e.g., a wallet insert, a plaque, ornament, etc.).

Other alternatives may be considered compatible with the present invention, for example, the charms 52 may be in the form of LED lights displayed to the user on a base item such as a digital watch. Further, undisclosed embodiments of the physical anchor 50 may be implemented using the motivational system 10, which should be considered within the scope of the present invention.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A computer enabled motivational system comprising the steps of:
transmitting, via a central computer, a sign up form that includes a field for receiving a shipping address of the user;
transmitting, via a central computer, a plurality of questions about reasons that motivate a user;
receiving, by the central computer, a plurality of answers to the questions;
determining most pertinent reasons that motivate the user;
transmitting the most pertinent reasons to a manufacturer computer;
manufacturing a physical anchor that is adapted to be worn by the user, which has been imprinted with the most pertinent reasons; and
shipping the physical anchor to the shipping address of the user.
